(19) United States
(12) Patent Application Publication
(10) Pub. No.: US 2003/0052240 A1
(43) Pub. Date: Mar. 20, 2003

(54) Satellite dish stand

(76) Inventor: David Roy Springett, Sacramento, CA (US)

Correspondence Address: Daniel P. Maguire, 423 E Street, Davis, CA, 95616, US

(21) Appl. No.: 09/957,949

(22) Filed: Sep. 14, 2001

(51) Int. Cl. F16M 11/00

(52) U.S. Cl. 248/163.1

(57) ABSTRACT

A portable satellite dish stand is disclosed, for use in providing satellite communications in conjunction with a portable computer classroom or other vehicle. The satellite stand has a stabilization plate that secures the stand against wind using the weight of the vehicle. The stand is lightweight and easy to assemble, and can be assembled without using any tools because it uses quick-release positive locking pins to join the components of the stand. Although it is big enough to accommodate virtually any portable satellite dish, when disassembled the stand is small enough for easy transport.

### CROSS-REFERENCE TO RELATED APPLICATIONS

The present application is related to the patent application titled “Portable Computer Classroom with High Speed Two-Way Network Access,” which is filed the same day as this application. The related application is not admitted to be prior art with respect to the present invention.

### BACKGROUND OF THE INVENTION

1.) Field of the Invention

The present invention relates to products for supporting satellite dishes and other devices that send and receive signals.

2.) Background of the Invention

Satellite communication is an increasingly important method of sending and receiving computer data. Using a satellite dish and a portable computer, computer users can access the internet without a telephone or other land-based connection. This technology makes it possible to bring the internet and computer technology to previously inaccessible areas, such as rural regions, or inner city areas where the infrastructure for computer communication is unavailable or inadequate. Thus, satellite technology is an important part of the effort to bridge the “digital divide.”

However, portable satellite communication can be difficult, because of the competing requirements of portability and stability. To be portable, the satellite station must be lightweight, but it also must be sturdy and stable, so that the satellite dish can be precisely oriented relative to the orbiting satellite. The difficulty is exacerbated by the fact that the satellite dish can act as a sail, capturing wind gusts and upsetting the satellite stand. In the past, ballast, such as a stone or bag of sand, has been used to stabilize portable satellite stands. But such ballast often does not provide the necessary stability, and requires users to carry stones or sand with them, thereby limiting portability.

Thus, there is a need for a lightweight, portable, and easy to assemble satellite stand that can be securely but temporarily anchored, without the need for cumbersome ballast.

### BRIEF SUMMARY OF THE INVENTION

The present invention is a portable, lightweight satellite dish stand, featuring two legs, a mast, a plurality of supports, and a stabilization plate. The stand is especially useful in conjunction with a portable computer classroom, since the vehicle that creates the classroom can stabilize the stand by driving onto the stabilization plate. The stand also features a cross support on one of its legs, to add rigidity and therefore prevent the leg from bowing or flexing with the wind.

The stand is easy to assemble, without using any tools, and can be assembled in minutes by persons with little or no training. It can accommodate virtually any portable satellite dish. Preferably, it is made of aluminum, although other lightweight, rigid materials can be used.

### BRIEF DESCRIPTION OF THE DRAWINGS

FIG. 1 is a perspective view of a satellite stand embodying the present invention.

FIG. 2 is a plan view of a satellite stand embodying the present invention.

FIG. 3 is a side view of a satellite stand embodying the present invention.

FIG. 4 is a front view of a satellite stand embodying the present invention.

FIG. 5 is a back view of a satellite stand embodying the present invention.

FIG. 6 is a cross-sectional view of a satellite stand as shown in FIG. 3, taken along line 6-6.

FIG. 7 is a cross-sectional view of a satellite stand as shown in FIG. 3, taken along line 7-7.

FIG. 8 is a cross-sectional view of a satellite stand as shown in FIG. 4, taken along line 8-8.

FIG. 9 is a cross-sectional view of a satellite stand as shown in FIG. 4, taken along line 9-9.

FIG. 10 is a cross-sectional view of a satellite stand as shown in FIG. 4, taken along line 10-10.

FIG. 11 is a cross-sectional view of a satellite stand as shown in FIG. 5, taken along line 11-11.

### DETAILED DESCRIPTION

In its preferred embodiment, the satellite dish of the present invention comprises two legs, a mast, a plurality of supports connecting the legs to the mast, and a stabilization plate, for securing the stand.

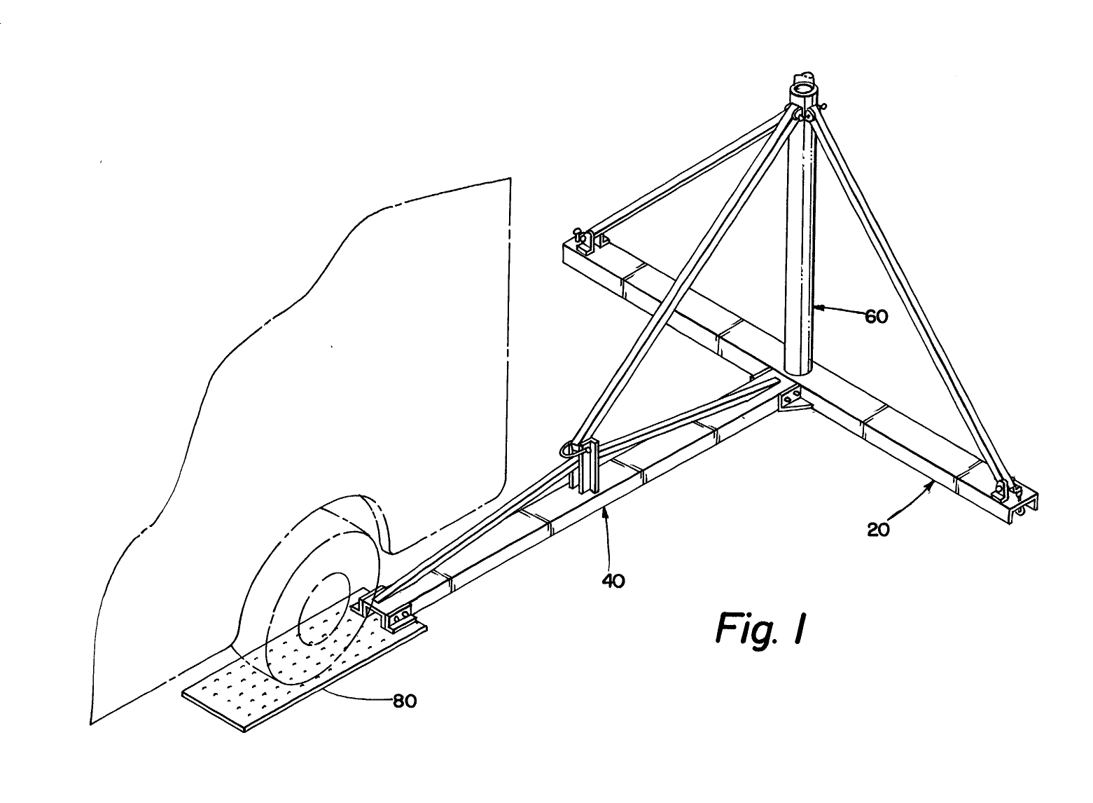

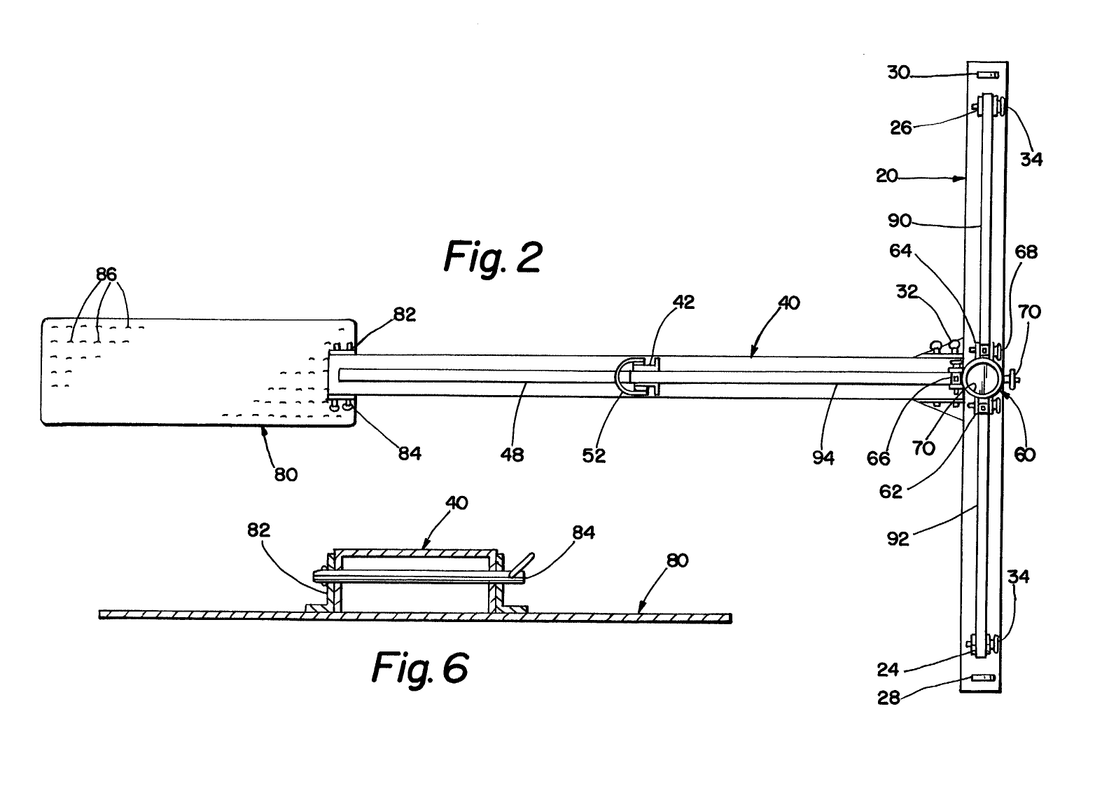

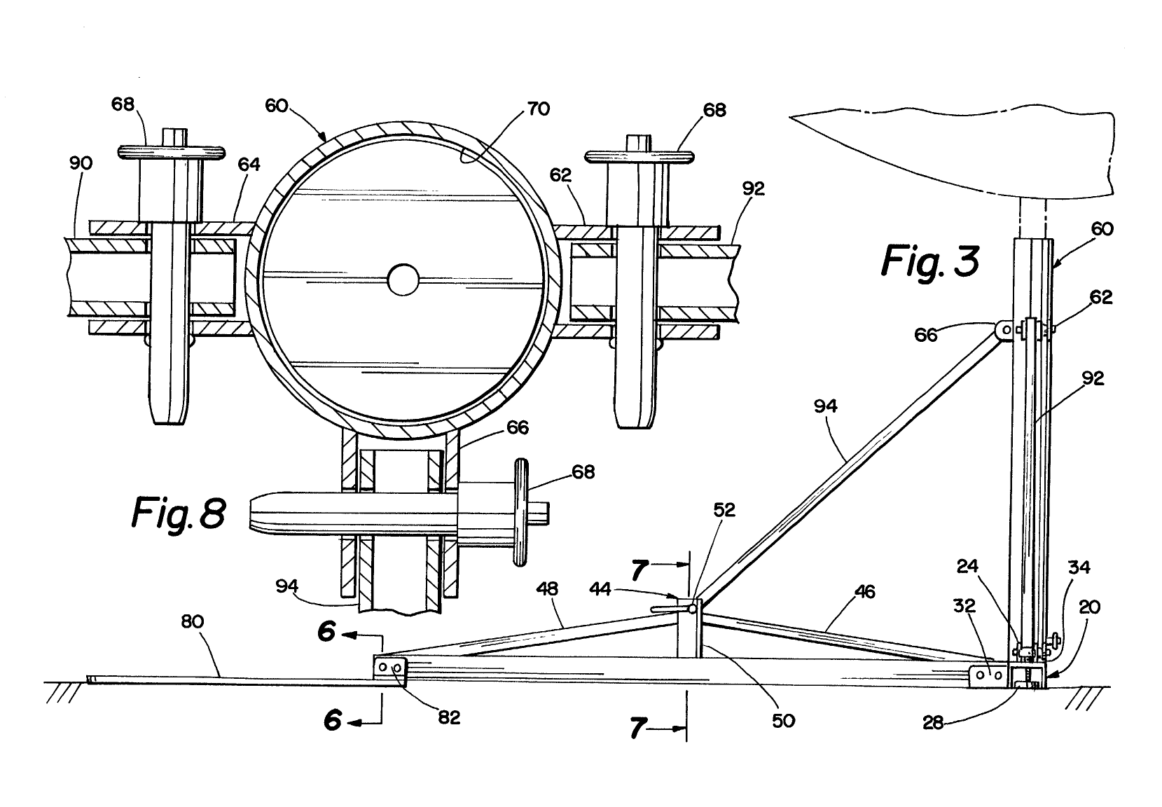

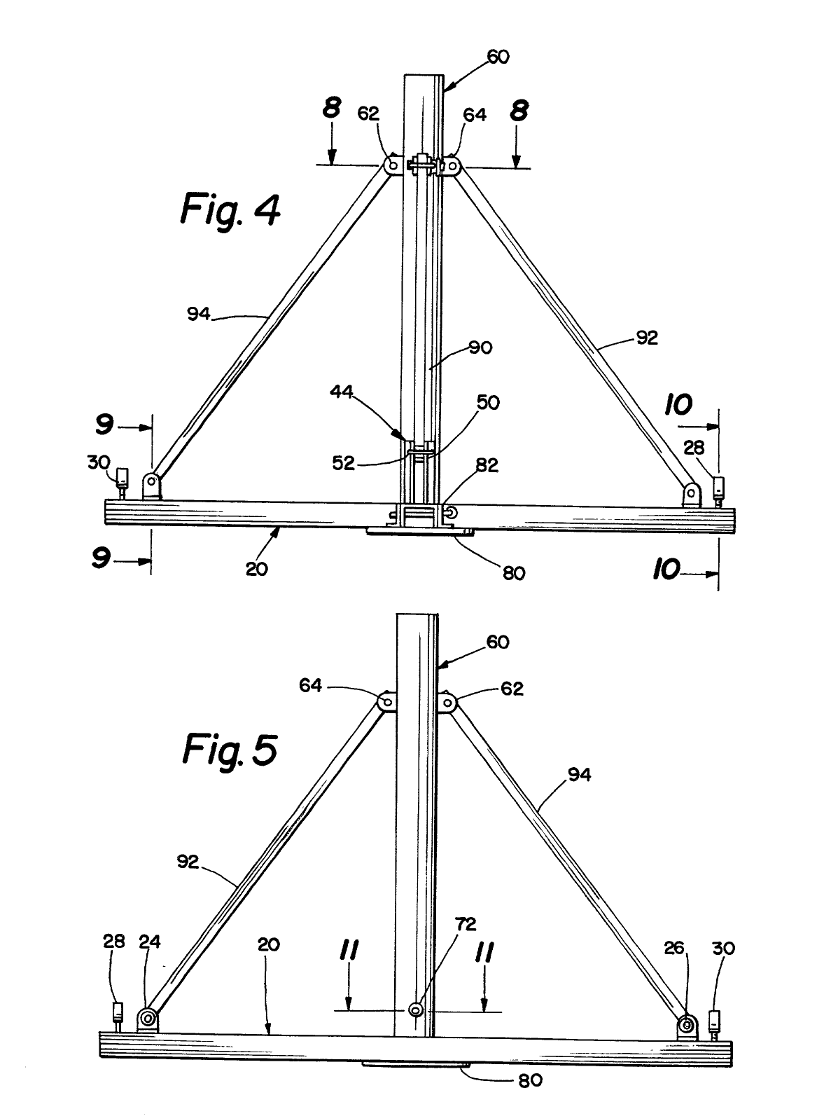

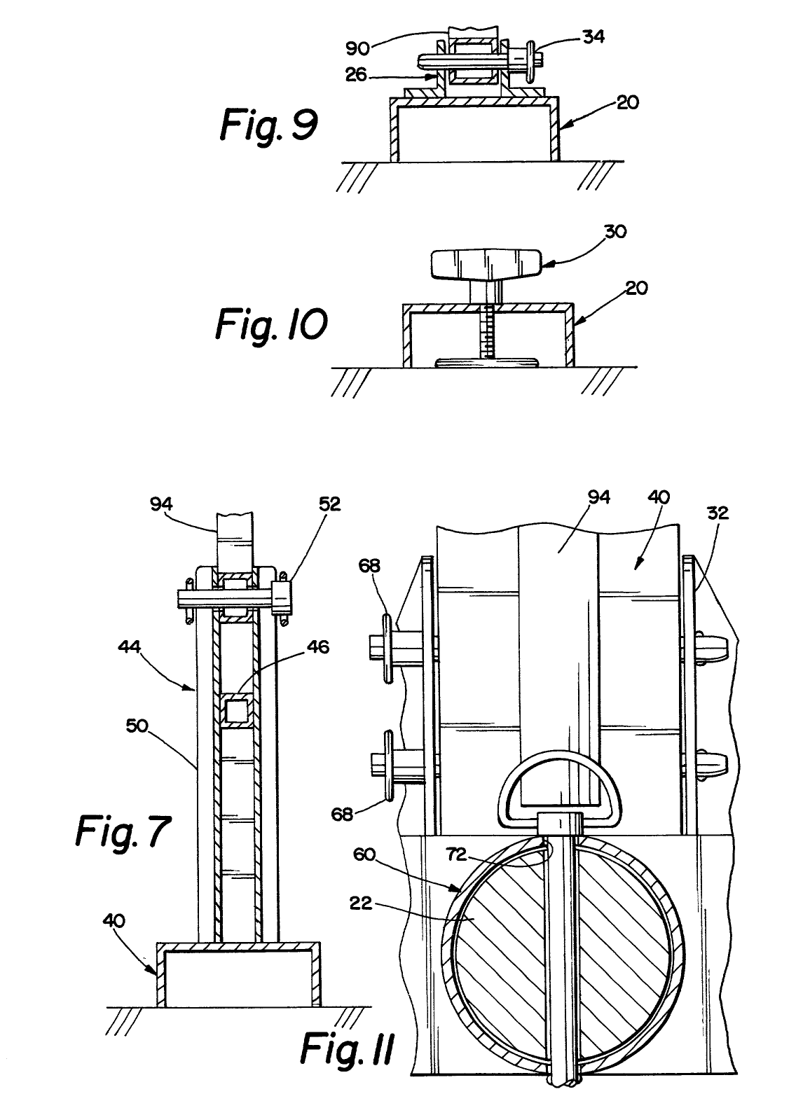

The first leg, 20, as illustrated in FIGS. 1, 2, 4 & 5, is an elongated section of aluminum, with means to receive the mast. In the preferred embodiment, the mast attaches to the first leg by fitting onto a mounting cylinder, 22, that extends from the first leg, and that has a diameter slightly smaller than the diameter of the mast. The mast can be secured to the mounting cylinder by a positive locking pin, as illustrated in FIG. 11, or by a screw or any other means that provide for a secure attachment. The first leg has a first coupler, 24, and a second coupler, 26, for receiving the supports, 92 & 94, that help secure the mast. These couplers take the form of a pair of raised plates, having aligned apertures for entry of pins, 34. In the preferred embodiment, the pins are positive locking pins, that use a ball bearing to lock the pin into place. Suitable positive locking pins are available from Avibank Mfg. Inc., 11500 Sherman Way, North Hollywood, Calif. As displayed in FIGS. 2, 4 & 5, the first leg also includes leveling nuts, 28 & 30, which can be used to differentially raise or lower either of the ends of the first leg, thereby making it easier to securely position the stand on uneven surfaces. These leveling nuts are disposed at opposite ends of the first leg. The first leg also contains a third coupler, 32, to removably attach the first leg to the second leg, 40. As with the other couplers, the third coupler comprises two parallel extensions, with aligned pairs of holes for receiving positive locking pins. In assembling the stand, the coupler receives one end of the second coupler, and is secured by using positive locking pins. In the preferred embodiment, the first leg is approximately 8 feet long and 3 inches wide, although other dimensions could be used. The cylinder and couplers can be attached by any conventional means, and in a preferred embodiment of this invention are attached using conventional welding processes.

Like the first leg, the second leg, 40, is an elongated section of aluminum. It has holes at each end, for attachment to the first leg, and for attachment to the stabilization plate, 80. Its chief feature is a cross-support, 44, that adds rigidity and helps to prevent the stand from bowing or twisting in the wind. In the preferred embodiment, this cross support takes the form of a two outer support legs, 46 & 48, secured to a cross-support base, 50, forming a triangular support. The cross-support has a fourth coupler, 42, that attaches to a support, 94. The fourth coupler attaches to the support using a pin, 52.

In a preferred embodiment of the present invention, the first and second legs form the base of the stand. There are numerous other ways to form the base of the satellite stand of the present invention, including a tripod, and other leg configurations. By the term “base,” this patent refers generally to the structure that provides the support for the satellite dish.

The mast, 60, is a hollow tube extending upwardly from the first leg, and is used to support the satellite dish. It contains a fifth coupler and a sixth coupler, 62 & 64, disposed towards the top of the mast, which secure the mast to the supports, 92 & 94, using pins 68. The mast has a first opening, 70, at its top, for receiving the satellite dish. The present invention can accommodate many different types of satellite dishes, and with an adapter, can likely accommodate virtually any portable satellite dish. The mast also has a second opening, 72, for securing the mast to the cylinder, using a pin or screw. If a pin is used, a third opening is needed in the mast, opposite to the second opening, to accommodate the pin. FIG. 11 illustrates the attachment of the mast to the cylinder using a pin.

A stand embodying the present invention could be constructed without a mast, by attaching the dish directly to the base. However, the mast is a convenient means to add elevation, which might be necessary to enable the satellite dish to effectively communicate with a satellite.

The stabilization plate, 80, is used to stabilize the stand using the weight of a vehicle. The stabilization plate has an eighth coupler, 82, which is used to secure the stabilization plate to the second leg using pins, 84. The stabilization plate has surface markings, 86, that increase the traction on the plate, helping to ensure that the vehicle securely holds the plate, and therefore the entire stand. In the preferred embodiment of the invention, the plate is attached to the second leg, but could also be attached to the same leg as the mast, i.e., the first leg.

Preferably, the stand is made of aluminum, although other strong, lightweight materials like fiberglass, wood, or mylar could be used.

In operation, the stand can be assembled in a matter of minutes, without using any tools. The vehicle can be driven onto the stabilization plate before or after the stand is assembled, although it is usually more covenant to assemble the stand first. Once secured by the vehicle, the stand is stable enough to withstand even the strongest gust of wind.

I claim:

1.) A portable satellite dish stand, comprising:
a base; and
a stabilization plate for securing the stand using the weight of a vehicle, said plate attached to said base.

2.) The stand according to claim 1, additionally comprising a mast attached to said base for receiving a satellite dish.

3.) The stand according to claim 2, wherein said base comprises a plurality of legs, said legs removably attached to each other.

4.) The stand according to claim 3, wherein said stabilization plate contains surface markings, thereby increasing traction.

5.) The stand according to claim 4, wherein said mast is attached to said base by positive locking pins.

6.) The stand according to claim 5, wherein said plate is attached to said base by positive locking pins.

7.) The stand according to claim 6, wherein said legs are attached to each other by positive locking pins.

8.) The stand according to claim 7, additionally comprising a support connecting one of said legs to said mast.

9.) The stand according to claim 8, wherein said stand is made of aluminum.

10.) The stand according to claim 9, wherein said base has two ends, and wherein said base has means for differentially adjusting the elevation of said ends.

11.) A method of securing a portable satellite dish stand, comprising the steps of:
providing a portable satellite dish stand with a stabilization plate; and
driving a vehicle onto to said plate.

12.) The method of claim 11, wherein said vehicle has been customized to serve as a computer classroom.

13.) A portable satellite dish stand, comprising:
a first leg;
a second leg, said second leg removably attached to said first leg;
a mast attached to said first leg for receiving a satellite dish; and
a stabilization plate attached to said second leg for securing the stand using the weight of a vehicle.

14.) A portable satellite dish stand, comprising:
a first leg;
a second leg, said second leg removably attached to said first leg;
a mast attached to said first leg for receiving a satellite dish; and
a stabilization plate attached to said first leg for securing the stand using the weight of a vehicle.

15.) A portable satellite dish stand, comprising:
a base; and
means for stabilizing said base using the weight of a vehicle.
